(19) United States
(12) Patent Application Publication
(10) Pub. No.: US 2026/0043538 A1
(43) Pub. Date: Feb. 12, 2026

(54) LIGHT FIXTURE HEAT SINK WITH PASSIVE AIR FLOW

(71) Applicant: SIGNIFY HOLDING B.V., EINDHOVEN (NL)

(72) Inventor: VOYA VIDAKOVIC, MARIETTA, GA (US)

(21) Appl. No.: 19/101,927

(22) PCT Filed: Aug. 4, 2023
(86) PCT No.: PCT/EP2023/071627

§ 371 Date: Feb. 7, 2025

Related U.S. Application Data
(60) Provisional application No. 63/396,069, filed on Aug. 8, 2022.

(30) Foreign Application Priority Data
Aug. 12, 2022 (EP) 22190095.4

(51) Int. Cl. F21V 29/77

(52) U.S. Cl. CPC F21V 29/777

(57) ABSTRACT

A light fixture (100), comprising: a light module; and a heat sink unit (102) comprising: an upper heat sink (104) having a wall section (310) and a cavity floor (402), wherein the cavity floor (402) is below a low-pressure cavity (128) and wherein the wall section (310) is positioned around the low-pressure cavity (128) and the cavity floor (402); a lower heat sink (106) attached to the upper heat sink (104), wherein the light module is attached to the lower heat sink; and air flow channels (502, 504, 522, 702, 704) that provide flow paths for air that enters air intake ports (302, 304, 532, 714, 716) of the heat sink unit (102) to travel to the low-pressure cavity (128), wherein the cavity floor (402) is located such that the air enters the low-pressure cavity (128) from the air flow channels through one or more gaps (604, 720, 722) that are between the wall section (310) and the cavity floor (402).

### TECHNICAL FIELD

The present disclosure relates generally to lighting solutions, and in particular to passive heat sinks for light fixtures and light fixtures that include passive heat sinks.

### BACKGROUND

Some light fixtures have components that produce heat. For example, a light module of a light fixture may produce heat that needs to be dissipated away from the light module and other sensitive components of the light fixture. To illustrate, dissipating heat generated by a light emitting diode (LED) light module away from a light fixture may be important for the durability of the light fixture. One approach to dissipating heat produced by light fixture components is to use a heat sink. While using a heat sink along with forced air flow (e.g., using a fan) to move heat away from sensitive light fixture components may increase thermal dissipation, such an approach may sometimes be too expensive and challenging, for example, because of space constraints. Thus, a heat sink that facilitates passive air flow may be desirable.

### SUMMARY

The present disclosure relates generally to lighting heat sink solutions, and in particular to passive heat sinks for light fixtures and light fixtures that include passive heat sinks. In an example embodiment, a heat sink unit for use in light fixtures includes an upper heat sink having a wall section and a cavity floor, where the cavity floor is below a low-pressure cavity and where the wall section is positioned around the low-pressure cavity and the cavity floor. The heat sink unit further comprises a lower heat sink attached to the upper heat sink. The heat sink unit also comprises air flow channels that provide flow paths for air that enters air intake ports of the heat sink unit to travel to the low-pressure cavity. The cavity floor is located such that the air enters the low-pressure cavity from the air flow channels through one or more gaps that are between the wall section and the cavity floor.

In another example embodiment, a light fixture includes a light module and a heat sink unit. The heat sink unit for use in light fixtures includes an upper heat sink having a wall section and a cavity floor, where the cavity floor is below a low-pressure cavity and where the wall section is positioned around the low-pressure cavity and the cavity floor. The heat sink unit further comprises a lower heat sink attached to the upper heat sink, where the light module is attached to the lower heat sink. The heat sink unit also comprises air flow channels that provide flow paths for air that enters air intake ports of the heat sink unit to travel to the low-pressure cavity. The cavity floor is located such that the air enters the low-pressure cavity from the air flow channels through one or more gaps that are between the wall section and the cavity floor.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIG. 1 illustrates a lighting fixture including a heat sink unit according to an example embodiment;

FIGS. 2A and 2B illustrate a lighting device of the lighting fixture of FIG. 1 according to an example embodiment;

FIG. 3 illustrates the heat sink unit of the lighting fixture of FIG. 1 according to an example embodiment;

FIG. 4 illustrates an exploded view of the heat sink unit of FIG. 3 according to an example embodiment;

FIGS. 5A and 5B illustrate different bottom views of the upper heat sink of the heat sink unit of FIG. 3 according to an example embodiment;

FIG. 6 illustrates a top view of the upper heat sink of the heat sink unit of FIG. 3 according to an example embodiment; and

FIG. 7 illustrates a cross-sectional view of the upper heat sink of the heat sink unit of FIG. 3 according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the figures, the same reference numerals used in different figures designate like or corresponding but not necessarily identical elements.

### DETAILED DESCRIPTION OF THE EXAMPLE EMBODIMENTS

In the following paragraphs, particular embodiments will be described in further detail by way of example with reference to the figures. In the description, well known components, methods, and/or processing techniques are omitted or briefly described. Furthermore, reference to various feature(s) of the embodiments is not to suggest that all embodiments must include the referenced feature(s).

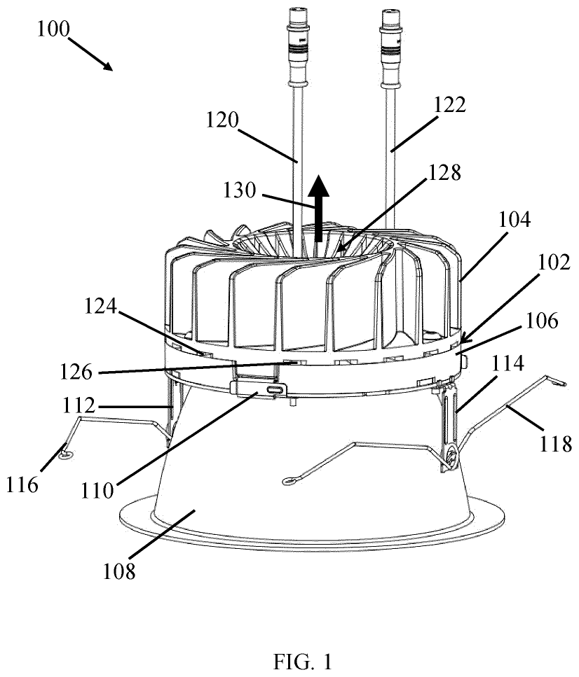

Turning now to the drawings, example embodiments are described. FIG. 1 illustrates a lighting fixture 100 including a heat sink unit 102 according to an example embodiment. In some example embodiments, the light fixture 100 includes the heat sink unit 102 that includes an upper heat sink 104 and a lower heat sink 106. The light fixture 100 may also include a trim 108 that is attached to the lower heat sink 106. For example, the trim 108 may be attached to the lower heat sink 106 by one or more brackets such as a bracket 110 or using other means as can be readily understood by those of ordinary skill in the art with the benefit of this disclosure.

In some example embodiments, the light fixture 100 may include torsion springs 116, 118 that are attached to attachment brackets 112, 114. The attachment brackets 112, 114 may be attached to the trim 108, and the torsion springs 116, 118 may be used to attach the light fixture 100 to a structure behind a ceiling. In some alternative embodiments, the light fixture 100 may be installed using other components instead of or in addition to the torsion springs 116, 118 as can be readily understood by those of ordinary skill in the art with the benefit of this disclosure. One or more electrical cables, such as electrical cables 120, 122, may be used to provide power to one or more light modules of the light fixture 100. For example, when the light fixture 100 may include a single light module, power may be provided to the light module via, for example, the electrical cable 122, and the electrical cable 120 may be omitted.

In some example embodiments, the heat sink unit 102 includes air intake ports, such as air intake ports 124, 126, that are located around the heat sink unit 102. As explained below in more detail, the air intake ports including the air intake ports 124, 126 are in fluid communication with a low-pressure cavity 128 of the upper heat sink 104 via air flow channels extending through the heat sink unit 102. To illustrate, relatively cool air may enter through the air intake ports 124, 126 and other air intake ports and, as the air travels through the air flow channels, the air may become warmer as a result of heat transfer from the upper heat sink 104 and the lower heat sink 106. For example, the heat dissipated by the upper heat sink 104 may be heat generated by one or light modules of the light fixture 100 and transferred to the upper heat sink 104 through the lower heat sink 106. The warmer air may travel upward and away from the heat sink unit 102 as illustratively indicated by the arrow 130. The heat sink unit 102 may also dissipate heat on the outside of the heat sink unit 102 thereby heating up the air on around the heat sink unit 102. The upper heat sink 104 and the lower heat sink 106 may be made from one or more materials such as steel and/or other metallic and/or non-metallic materials using methods such as molding, milling, cutting, etc. as can be readily understood by those of ordinary skill in the art with the benefit of this disclosure.

As explained in more detail below, the low-pressure cavity 128 draws relatively cool air from outside the heat sink unit 102 through the air intake ports, such as the air intake ports 124, 126, and the air flow channels of the heat sink unit 102 that are connected to the air intake ports. The flow of air between the air intake ports 124, 126 and the low-pressure cavity 128 facilitates the dissipation of heat from the heat sink unit 102 away from the light fixture 100.

In some alternative embodiments, the light fixture 100 may be a different type of light fixture without departing from the scope of this disclosure. In some alternative embodiments, one or more components of the light fixture 100 may be omitted or replaced with other components without departing from the scope of this disclosure. In some alternative embodiments, one or more components of the light fixture 100 may have other shapes than shown without departing from the scope of this disclosure.

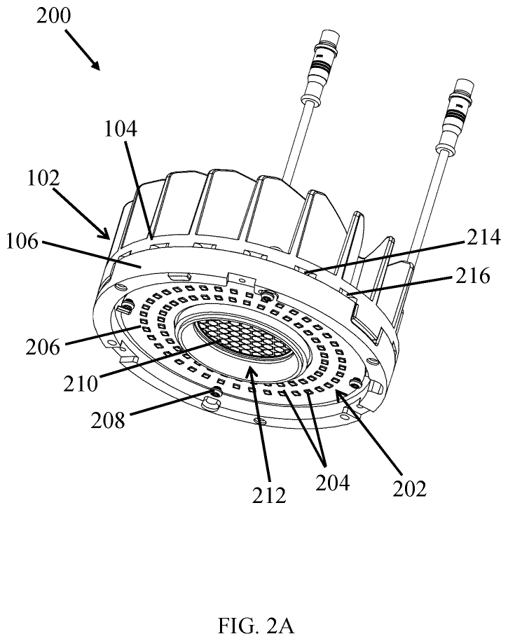

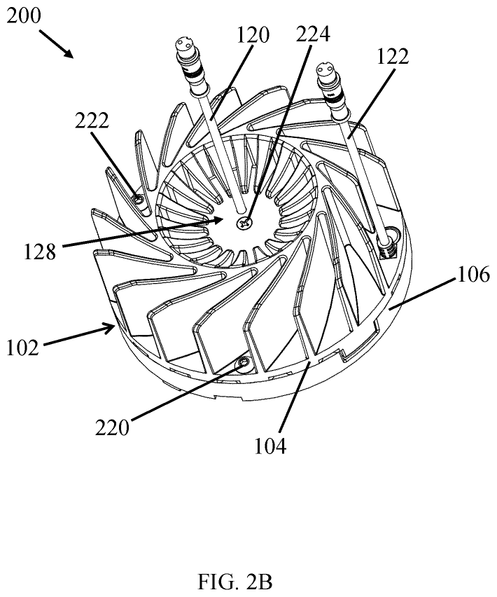

FIGS. 2A and 2B illustrate a lighting device 200 of the lighting fixture 100 of FIG. 1 according to an example embodiment. Referring to FIGS. 1-2B, in some example embodiments, the light device 200 includes the heat sink unit 102 that includes the upper heat sink 104 and the lower heat sink 106. The upper heat sink 104 and the lower heat sink 106 may be securely attached to each other by fasteners, such as fasteners (e.g., screws) 220, 222. The lighting device 200 may include a light module 202 that is attached to the lower heat sink 106. For example, the light module 202 may be an LED printed circuit board assembly (PCBA) that include a printed circuit board (PCB) 206 and multiple LEDs, such as LEDs 204, that are attached to the PCB 206. The LEDs may emit the light that is provided by the lighting fixture 100, for example, to illuminate an area below the light fixture 100. Electrical power may be provided to the light module 202 via the electrical cable 122.

In some example embodiments, the light module 202 may be attached to the lower heat sink 106 using fasteners (e.g., screws), such as a fastener 208, and/or other means (e.g., an adhesive). Heat produced by the light module 202 may be transferred to and dissipated by the heat sink unit 102. Relatively cool air may be drawn into air intake ports, such as air intake ports 124, 126, 214, 216, of the heat sink unit 102 and the cool drawn-in air may become warmer from heat dissipated by the heat sink unit 102 as the air travels to the low-pressure cavity 128 through air flow channels of the heat sink unit 102. As described in more detail below, air flow channels of the heat sink unit 102 connect the air intake ports of the heat sink unit 102, such as air intake ports 124, 126, 214, 216, with the low-pressure cavity 128.

In some example embodiments, the lighting device 200 may include a light module 210. For example, the light module 210 may be an ultraviolet (UV) light module that emits UV light through an opening 212 of the lower heat sink 106. The light module 210 may be positioned in a light module cavity of the upper heat sink 104 and may be attached to the upper heat sink 104 by a fastener 224 (e.g., a screw). Alternatively, the light module 210 may emit an illumination light instead of a UV light without departing from the scope of this disclosure. Electrical power may be provided to the light module 210 via the electrical cable 120. In some alternative embodiments, the light module 210 may be omitted without departing from the scope of this disclosure.

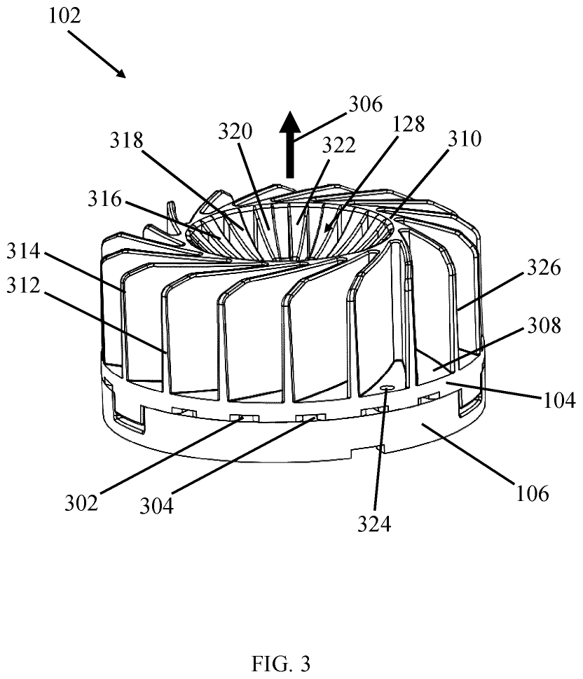

FIG. 3 illustrates is the heat sink unit 102 of the lighting fixture 100 of FIG. 1 according to an example embodiment. Referring to FIGS. 1-3, as described above, the heat sink unit 102 may include the upper heat sink 104 and the lower heat sink 106. The upper heat sink 104 may include attachment holes, such as an attachment hole 324, that are used in the attachment of the upper heat sink 104 to the lower heat sink 106. For example, the fastener 222 (more clearly shown in FIG. 2B) may be inserted in the attachment hole 324. The upper heat sink 104 and the lower heat sink 106 may be attached to each other such that at least some of the heat transferred to the lower heat sink 106 from the light module 202 may be transferred to the upper heat sink 104, for example, through conduction.

In some example embodiments, the heat sink unit 102 may include air intake ports 302, 304 shown in FIG. 3, the air intake ports 124, 126, 214, 216 shown in FIGS. 1-2B as well as other air intake ports that may be located around a perimeter of the heat sink unit 102. The air intake ports 124, 126, 214, 216, 302, 304 as well as the other air intake ports may serve as openings for relatively cool air to enter air flow channels of the heat sink unit 102, where the relatively cool air becomes warmer air from heat dissipated by the upper heat sink 104 and the lower heat sink 106. The warmer air may travel through the air flow channels to the low-pressure cavity 128 of the upper heat sink 104 and move up and away from the upper heat sink 104 in the general direction shown by the arrow 306 in FIG. 3.

In some example embodiments, the upper heat sink 104 may include a base section 308 and a wall section 310. For example, the base section 308 may extend outwardly from the wall section 310, where the wall section 310 extends upwardly from the base section 308. The upper heat sink 104 may also include exterior fins, such as exterior fins 312, 314, 326. For example, the exterior fins 312, 314, 326 may extend outwardly from the wall section 310 and upwardly from the base section 308. In some example embodiments, the exterior fins 312, 314, 326 as well as the other exterior fins of the upper heat sink 104 may extend out from one or both of the base section 308 and the wall section 310. The exterior fins 312, 314, 326 may provide increased surface area that helps to dissipate heat from the upper heat sink 104. For example, the exterior fins may be in a turbine configuration. The turbine-shape of the exterior fins, such as the exterior fins 312, 314, 326, may aid in creating a natural centralized vortex of heat rising, which may help lower the pressure of the low-pressure cavity 128 and increase air flow from the air intake ports, such as the air intake ports 124, 126, 214, 216, 302, 304, to the low-pressure cavity 128 through air flow channels of the heat sink unit 102.

In some example embodiments, the upper heat sink 104 may include interior fins, such as interior fins 316, 318, 320, 322, that extend inwardly from the wall section 310 of the upper heat sink 104. To illustrate, the interior fins 316, 318, 320, 322 as well as the other interior fins of the upper heat sink 104 may extend inwardly on the interior side of the wall section 310, for example, towards the center of the low-pressure cavity 128. The interior fins 316, 318, 320, 322 as well as the other interior fins of the upper heat sink 104 may provide increased surface area that helps to dissipate heat from the upper heat sink 104. For example, the interior fins may be in a turbine configuration.

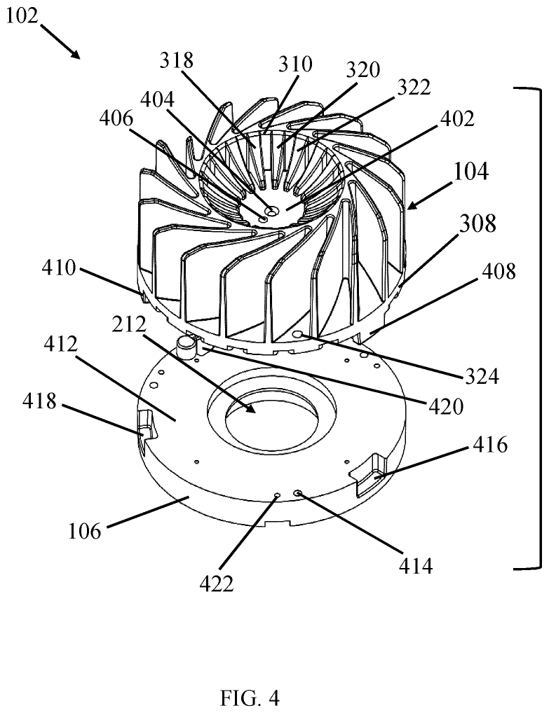

FIG. 4 illustrates an exploded view of the heat sink unit 102 of FIG. 3 according to an example embodiment. Referring to FIGS. 1-4, in some example embodiments, the upper heat sink 104 may include a cavity floor 402 that is surrounded by the wall section 310 of the upper heat sink 104. The interior fins of the upper heat sink 104, such as the interior fins 316, 318, 320, 322, may extend between the wall section 310 and the cavity floor 402. For example, the interior fins of the upper heat sink 104 may be attached to the wall section 310 and to the cavity floor 402. For example, the cavity floor 402 may be held attached to the wall section 310 of the upper heat sink 104 by the interior fins. To illustrate, at least some sections of the outer perimeter of the cavity floor 402 or the entire outer perimeter of the cavity floor 402 may be spaced from the wall section 310.

As more clearly shown in FIGS. 3 and 4, in some example embodiments, the interior fins of the upper heat sink 104 may be slanted or curved down as the interior fins extend from the wall section 310 towards the cavity floor 402. The interior fins of the upper heat sink 104 may be spaced from each other, where warm air can enter the low-pressure cavity 128 between adjacent interior fins from below the cavity floor 402. For example, relatively cool air that enters the heat sink unit 102 through air intake ports, such as the air intake ports 302, 304, may become warmer from heat transferred from the upper heat sink 104 and from the lower heat sink 106, and the air that has become warmer may enter the low-pressure cavity 128 between adjacent interior fins such as, for example, between the interior fins 316 and 318 and between the interior fins 318 and 320. In general, the air intake ports of the heat sink unit 102, such as the air intake ports 302, 304, are located around a perimeter of the heat sink unit 102 at one or more levels below the cavity floor 402.

In some example embodiments, the cavity floor 402 may include a cable routing hole 406 that may be used to route, for example, the electrical cable 120 shown in FIG. 1. For example, the electrical cable 120 may be routed to the light module 210 (shown in FIG. 2A) through the cable routing hole 406. Alternatively, the cable routing hole 406 may be used to route the electrical cable 120 to the light module 202 (shown in FIG. 2A) without departing from the scope of this disclosure. The cavity floor 402 may also include an attachment hole 404 that may be used to extend the fastener 224 (shown in FIG. 2B) therethrough to attach the light module 210 (shown in FIG. 2A) to the cavity floor 402, where the light module 210 may be located on the opposite side of the cavity floor 402 from the low-pressure cavity 128 (as shown in FIG. 2A). The light module 210 may be positioned to emit a light through the opening 212 in the lower heat sink 106 to an area below the light fixture 100.

In some example embodiments, the upper heat sink 104 may include tabs 408, 410 that protrude down from the base section 308 of the upper heat sink 104. The tabs 408, 410 may be sized to fit in notches 416, 418 of the lower heat sink 106. For example, the tabs 408, 410 may be used to align the upper heat sink 104 with the lower heat sink 106 and to prevent unintended movement before the upper heat sink 104 and the lower heat sink 106 are securely attached by fasteners such as the fasteners 220, 220 (shown in FIG. 2B). To illustrate, the lower heat sink 106 may include an attachment hole 414 that is aligned with the attachment hole 324 in the upper heat sink 104, and the fastener 222 may be extended through the attachment holes 324 and 414 to securely attach the upper heat sink 104 with the lower heat sink 106. The fastener 220 and one or more other fasteners may also be extended through respective attachment holes in the upper heat sink 104 and the lower heat sink 106 to securely attach the upper heat sink 104 with the lower heat sink 106. A top surface 412 of the lower heat sink 106 may be in contact with the base section 308 of the upper heat sink 104 when the upper heat sink 104 is securely attached to the lower heat sink 106 to facilitate heat transfer from the lower heat sink 106 to the upper heat sink 104.

In some example embodiments, the lower heat sink 106 may include a cable routing hole 420 that is aligned with a corresponding hole in the upper heat sink 104 to route the electrical cable 122 (shown in FIG. 2B) to the light module 202 (shown in FIG. 2A). The lower heat sink 106 may also include light module attachment holes, such as the light module attachment hole 422. For example, fasteners, such as the fastener 208 (shown in FIG. 2A), may be inserted through the light module attachment holes to securely attach the light module 202 (shown in FIG. 2B) to the lower heat sink 106 on an opposite side of the lower heat sink 106 from the upper heat sink 104. In some alternative embodiments, the light module attachment holes, such as the light module attachment hole 422, may be omitted, and the light module 202 may be attached to the lower heat sink 106 by other means such as an adhesive, one or more bracket, and/or other attachment structures.

In some alternative embodiments, the upper heat sink 104 and the lower heat sink 106 may be integrally formed as a single component without departing from the scope of this disclosure. In some alternative embodiments, the base section 308 may have a different shape than shown without departing from the scope of this disclosure. As a non-limiting example, the base section 308 may have a rectangular outer perimeter shape. In some alternative embodiments, the upper heat sink 104 may have a different shape than shown without departing from the scope of this disclosure. In some alternative embodiments, the upper heat sink 104 may have a smaller or larger diameter than the lower heat sink 106 without departing from the scope of this disclosure. In some alternative embodiments, the upper heat sink 104 may include more or fewer exterior fins and/or interior fins than shown without departing from the scope of this disclosure. In some alternative embodiments, the exterior fins and the interior fins of the upper heat sink 104 may have different shapes than shown without departing from the scope of this disclosure. In some alternative embodiments, the tabs 408, 410 as well as other such tabs may be omitted without departing from the scope of this disclosure. Alternatively, the lower heat sink 106 may other structures including more tabs without departing from the scope of this disclosure. In some alternative embodiments, the perimeter of the low-pressure cavity 128 may be a non-round shape without departing from the scope of this disclosure. In some alternative embodiments, the attachment hole 404 and/or the cable routing hole 406 may be omitted or at different locations than shown without departing from the scope of this disclosure.

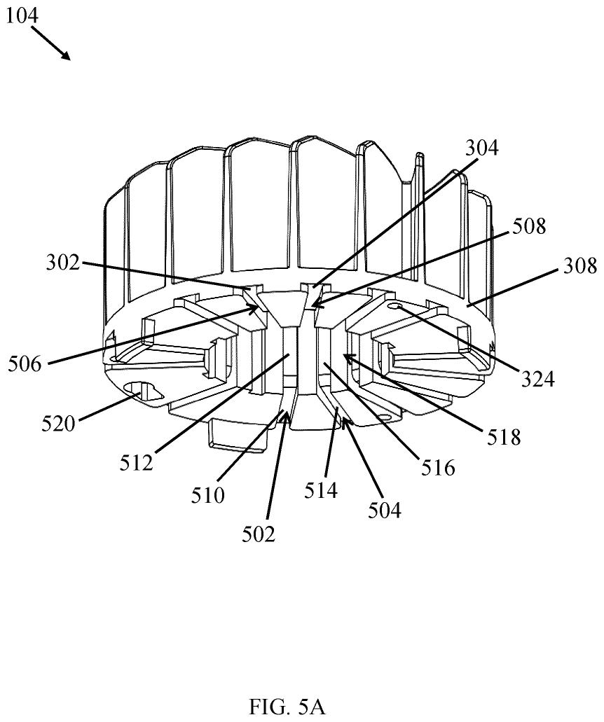

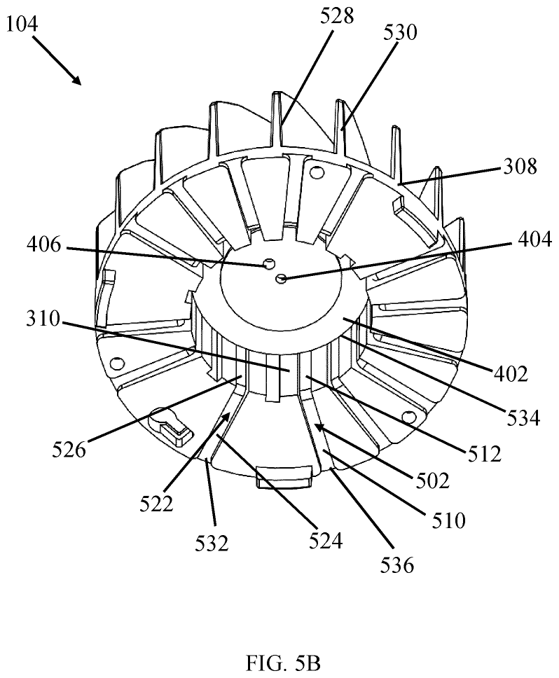

FIGS. 5A and 5B illustrate different bottom views of the upper heat sink 104 of the heat sink unit 102 of FIG. 3 according to an example embodiment. In some example embodiments, the upper heat sink 104 includes the base section 308 and the wall section 310. The upper heat sink 104 may also include air flow channels 502, 504, 506, 508, 522 as well as other air flow channels that are formed in the upper heat sink 104. For example, the air flow channel 502 may have air flow channel sections 510, 512, where the air flow channel section 510 is formed in the base section 308 of the upper heat sink 104 and where the air flow channel section 512 is formed in the wall section 310 of the upper heat sink 104. As another example, the air flow channel 504 may have air flow channel sections 514, 516, where the air flow channel section 514 is formed in the base section 308 of the upper heat sink 104 and where the air flow channel section 516 is formed in the wall section 310 of the upper heat sink 104. As yet another example, the air flow channel 522 may have air flow channel sections 524, 526, where the air flow channel section 524 is formed in the base section 308 of the upper heat sink 104 and where the air flow channel section 526 is formed in the wall section 310 of the upper heat sink 104. When the lower heat sink 106 is attached to the upper heat sink 104, the sections of the air flow channels (e.g., the air flow channel section 514) formed in the base section 308 of the upper heat sink 104 may be bound or otherwise close off by the lower heat sink 106 on the side of the sections of the air flow channels facing the lower heat sink 106.

In some example embodiments, the air intake port 302 provides an opening for air (e.g., relatively cool air) to enter the air flow channel 506, where the air flows to the low-pressure cavity 128 (for example, shown in FIG. 2B) through the air flow channel 506. As the air travels through the air flow channel 506 to the low-pressure cavity 128, the air may become warmer as a result of heat transfer from the upper heat sink 104 and the lower heat sink 106.

In some example embodiments, the air intake port 304 provides an opening for relatively cool air to enter the air flow channel 508, where the air flows to the low-pressure cavity 128 (for example, shown in FIG. 2B) through the air flow channel 508. As the air travels through the air flow channel 508, the air may become warmer as a result of heat transfer from the upper heat sink 104 and the lower heat sink 106.

In some example embodiments, the air intake port 536 provides an opening for relatively cool air to enter the air flow channel 502, where the air flows to the low-pressure cavity 128 (for example, shown in FIG. 2B) through the air flow channel 502. As the air travels through the air flow channel 502, the air may become warmer as a result of heat transfer from the upper heat sink 104 and the lower heat sink 106.

In some example embodiments, the air intake port 532 provides an opening for relatively cool air to enter the air flow channel 522, where the air flows to the low-pressure cavity 128 (for example, shown in FIG. 2B) through the air flow channel 522. As the air travels through the air flow channel 502, the air may become warmer as a result of heat transfer from the upper heat sink 104 and the lower heat sink 106. Air that enters through other air intake ports becomes warmer as the air travels through the respective air flow channels to the low pressure cavity 128.

In some example embodiments, the air that travels through the air flow channels, such as the air flow channels 502, 504, 506, 508, 522, and may enter the low-pressure cavity 128 through one or more spaces/gaps (i.e., air exhaust ports) that are between the cavity floor 402 and the wall section 310 of the upper heat sink 104. For example, some sections of a perimeter 534 of the cavity floor 402 or the entire perimeter 534 of the cavity floor 402 may be spaced from the wall section 310. The relatively warmer air that enters the low-pressure cavity 128 may move up and away from the upper heat sink 104, thereby removing heat away from the upper heat sink 104. The low-pressure cavity 128 may draw in air through the air intake ports and respective air flow channels because of the relatively low air pressure in the low-pressure cavity 128 as compared to the air pressure at the air intake ports of the upper heat sink 104, such as the air intake ports 124, 126, 214, 216, 302, 304, 532, 536, shown for example in FIGS. 1, 2A, 2B, 3, 4, 5A, and/or 5B. Heat may also be dissipated into the air around the upper heat sink 104 by the exterior fins (e.g., exterior fins 528, 530) of the upper heat sink 104.

As shown in FIG. 5B, the cavity floor 402 may include the attachment hole 404 that may be used to extend the fastener 224 therethrough to attach the light module 210 that may be placed in the light module cavity 518 of the upper heat sink 104 shown in FIG. 5A. The cavity floor 402 may include the cable routing hole 406 that may be used to route the electrical cable 120 shown, for example, in FIG. 1 to the light module 210 that may be in the light module cavity 518. The upper heat sink 104 may also include a cable routing hole 520 that may be aligned with the cable routing hole 420 in the lower heat sink 106 that may be used to route the electrical cable 122 (shown in FIG. 2B) to the light module 202 (shown in FIG. 2A).

Because the low-pressure cavity 128 draws relatively cool air from outside the heat sink unit 102 through the air intake ports, such as the air intake ports 302, 304, where the air absorbs heat from the upper heat sink 104 and the lower heat sink 106 as the air travels through the air flow channels, such as the air flow channels 506, 508, heat can be more efficiently dissipated by the heat sink unit 102 than by another heat sink that does not provide such passive air flow. Because of the heat dissipation efficiency of the heat sink unit 102, the overall size of the heat sink unit 102 can be smaller than another heat sink that does not provide such air flow, thus potentially lowering the cost of associated with heat sinks of light fixtures.

In some alternative embodiments, the air intake ports and sections of the air flow channels of the upper heat sink 104 may instead be formed in the lower heat sink 106 without departing from the scope of this disclosure. In some alternative embodiments, the air intake ports and sections of the air flow channels of the upper heat sink 104 may instead be formed in both the upper heat sink 104 and the lower heat sink 106 as overlapping or non-overlapping air intake ports and air flow channels without departing from the scope of this disclosure. In some alternative embodiments, the upper heat sink 104 may include more or fewer air intake ports and/or air flow channels than shown without departing from the scope of this disclosure. In some alternative embodiments, the air intake ports and/or air flow channels shown in FIGS. 5A and 5B may be larger or smaller than shown without departing from the scope of this disclosure. In some alternative embodiments, air intake ports and/or air flow channels may have different shapes than shown without departing from the scope of this disclosure. In some alternative embodiments, the In some alternative embodiments, the air intake ports and/or air flow channels may be at different locations than shown without departing from the scope of this disclosure. In some alternative embodiments, the light module cavity 518 may be omitted without departing from the scope of this disclosure. For example, a part of the upper heat sink 104, a part of the lower heat sink 106, and/or another structure may be at the location of the light module cavity 518.

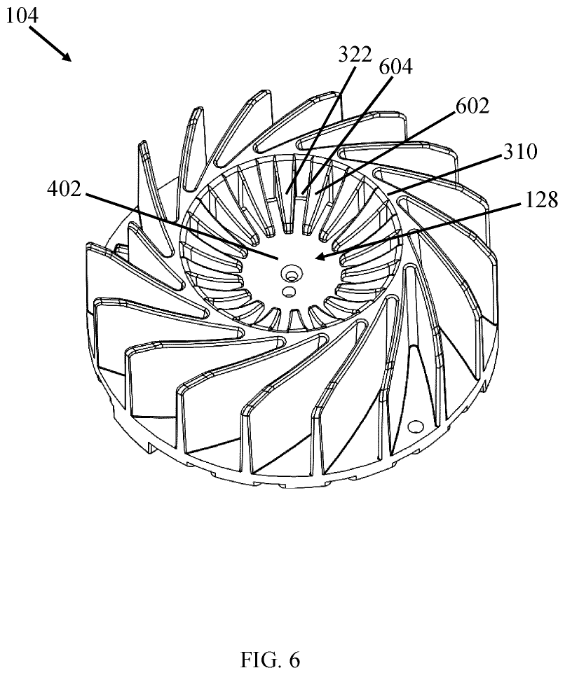

FIG. 6 illustrates a top view of the upper heat sink 104 of the heat sink unit 102 of FIG. 3 according to an example embodiment. Referring to FIGS. 1-6, in some example embodiments, the upper heat sink 104 includes interior fins, such as the interior fins 320, 322, 602. For example, the interior fins 320, 322, 602 may extend between the wall section 310 of the upper heat sink 104 and the cavity floor 402 of the upper heat sink 104 and may be attached to the wall section 310 and the cavity floor 402. To illustrate, the interior fins 320, 322, 602 may extend inwardly from the wall section 310 towards the center of the low-pressure cavity 128.

As described above, the wall section 310 surrounds the cavity floor 402 and the low-pressure cavity 128. Air that enters the air flow channels, such as the air flow channels 502, 504, 506, 508, 522, through the air intake ports may enter the low-pressure cavity 128 through spaces/gaps (i.e., air exhaust ports) between the cavity floor 402 and the wall section 310 of the upper heat sink 104. For example, air exiting one of the air flow channels (e.g., one of the air flow channels 502, 504, 506, 508, 522) may enter the low-pressure cavity 128 through the space/gap 604 that is between the perimeter 534 of the cavity floor 402 and the wall section 310. The air that enters the low-pressure cavity 128 through the space/gap 604 may move between the interior fins 322 and 602 before moving upward and away from the upper heat sink 104. In general, as the air moves in the low-pressure cavity 128, the flow of air between adjacent interior fins, such as the adjacent interior fins 322, 602, may facilitate additional transfer of heat from the upper heat sink 104 to the air in the low-pressure cavity 128.

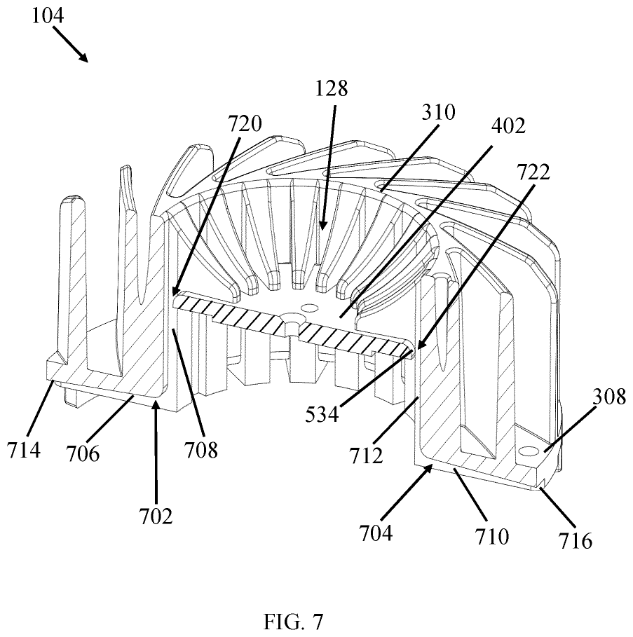

FIG. 7 illustrates a cross-sectional view of the upper heat sink 104 of the heat sink unit 102 of FIG. 3 according to an example embodiment. Referring to FIGS. 1-7, in some example embodiments, the upper heat sink 104 may include air flow channels 702, 704. The air flow channel 702 may include air flow channel sections 706, 708, where the air flow channel section 706 is formed in the base section 308 of the upper heat sink 104 and where the air flow channel section 708 is formed in the wall section 310 of the upper heat sink 104. The surface of the upper heat sink 104 above the air flow channel section 706 may be slanted upward as the air flow channel section 706 extends inwardly from the air intake ports 714 toward the air flow channel section 708, which may facilitate air flow from the air intake ports 714 to the low-pressure cavity 128. To illustrate, air may enter the air flow channel 702 through the air intake ports 714 and travel to the low-pressure cavity 128 through the air flow channel 702 as a result of the difference in air pressure at the low-pressure cavity 128 and air intake ports 714. The air may become warmer moving through the air flow channel 702 as a result of heat transfer from the upper heat sink 104 and from the lower heat sink 106 that may enclose/bound the flow channel section 706 from below when the upper heat sink 104 and the lower heat sink 106 are attached as shown, for example, in FIG. 1. The warmer air may enter the low-pressure cavity 128 from the air flow channel 702 through a space/gap 720 (i.e., air exhaust port) that is between the perimeter 534 of the cavity floor 402 and the wall section 310.

In some example embodiments, the air flow channel 704 may include air flow channel sections 710, 712, where the air flow channel section 710 is formed in the base section 308 of the upper heat sink 104 and where the air flow channel section 712 is formed in the wall section 310 of the upper heat sink 104. The surface of the upper heat sink 104 above the air flow channel section 710 may be slanted upward as the air flow channel section 710 extends inwardly from the air intake ports 716 toward the air flow channel section 712, which may facilitate air flow from the air intake ports 716 to the low-pressure cavity 128. To illustrate, air may enter the air flow channel 704 through the air intake ports 716 and travel to the low-pressure cavity 128 through the air flow channel 704 as a result of the difference in air pressure at the low-pressure cavity 128 (i.e., relatively lower air pressure) and air intake ports 716 (relatively higher air pressure). The air may become warmer moving through the air flow channel 704 as a result of heat transfer from the upper heat sink 104 and from the lower heat sink 106 that may enclose/bound the flow channel section 710 from below when the upper heat sink 104 and the lower heat sink 106 are attached as shown, for example, in FIG. 1. The warmer air may enter the low-pressure cavity 128 from the air flow channel 704 through a space/gap 722 (i.e., air exhaust port) that is between the perimeter 534 of the cavity floor 402 and the wall section 310. As described above, the sections of the perimeter 534 of the cavity floor 402 or the entirety of the perimeter 534 of the cavity floor 402 may be spaced from the wall section 310 to provide one or more spaces/gaps for air to enter the low-pressure cavity 128 from the air flow channels, such as the air flow channels 702, 704. For example, the space/gap 720 and the space/gap 722 may be separate spaces/gaps from each other or may be parts of the same spacing that extends around the cavity floor 402.

In some alternative embodiments, air may enter the low-pressure cavity 128 from the air flow channels through other openings such as openings in the cavity floor 402 instead of or in addition to one or more spaces/gaps between the cavity floor 402 and the wall section 310 of the upper heat sink 104. In some alternative embodiments, the air flow channels 702, 704 and other air flow channels of the upper heat sink 104 may have more sections and/or may have different shapes than shown without departing from the scope of this disclosure. In some alternative embodiments, the air intake ports and sections of the air flow channels of the upper heat sink 104 may instead be formed in the lower heat sink 106 and bound/enclosed from above by the upper heat sink 104 without departing from the scope of this disclosure. In some alternative embodiments, the lower heat sink 106 may include air intake ports and air flow channels that overlap with the air intake ports and sections of the air flow channels of the upper heat sink 104 without departing from the scope of this disclosure.

Although particular embodiments have been described herein in detail, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the scope of the following claims, the scope of which are to be accorded the broadest interpretation so as to encompass modifications and equivalent structures.

1. A heat sink unit for use in light fixtures, the heat sink unit comprising:
an upper heat sink having a wall section and a cavity floor wherein the cavity floor is below a low-pressure cavity, wherein the low-pressure cavity comprises interior fins that are attached to the wall section and the cavity floor and wherein the wall section is positioned around the low-pressure cavity and the cavity floor;
a lower heat sink attached to the upper heat sink; and
air flow channels that provide flow paths for air that enters air intake ports of the heat sink unit to travel to the low-pressure cavity wherein the cavity floor is located such that the air enters the low-pressure cavity from the air flow channels through one or more gaps that are between the wall section and the cavity floor.

2. The heat sink unit of claim 1, wherein first sections of the air flow channels are formed in a base section of the upper heat sink, wherein second sections of the air flow channels are formed in the wall section, and wherein the base section extends outwardly from the wall section.

3. The heat sink unit of claim 2, wherein the first sections of the air flow channels are bound by the lower heat sink

4. The heat sink unit of claim 1, wherein the one or more gaps are each located between respective adjacent interior fins.

5. The heat sink unit of claim 1, wherein the upper heat sink comprises exterior fins that extend out from the wall section, from the base section, or from both.

6. The heat sink unit of claim 1, wherein the air intake ports are located around a perimeter of the heat sink unit at one or more levels below the cavity floor.

7. The heat sink unit of claim 1, wherein the upper heat sink and the lower heat sink each comprise an electrical cable routing hole for routing an electrical cable to a light module.

8. The heat sink unit of claim 1, wherein the upper heat sink comprises a light module cavity that is below the cavity floor.

9. A light fixture, comprising:
a light module; and
a heat sink unit comprising:
an upper heat sink having a wall section and a cavity floor, wherein the cavity floor is below a low-pressure cavity and wherein the wall section is positioned around the low-pressure cavity and the cavity floor;
a lower heat sink attached to the upper heat sink, wherein the light module is attached to the lower heat sink; and
air flow channels that provide flow paths for air that enters air intake ports of the heat sink unit to travel to the low-pressure cavity, wherein the cavity floor is located such that the air enters the low-pressure cavity from the air flow channels through one or more gaps that are between the wall section and the cavity floor, wherein first sections of the air flow channels are formed in a base section of the upper heat sink, wherein second sections of the air flow channels are formed in the wall section and wherein the base section extends outwardly from the wall section.

10. The light fixture of claim 9, wherein the first sections of the air flow channels are bound by the lower heat sink.

11. The light fixture of claim 9, wherein the upper heat sink comprises interior fins that are in the low-pressure cavity and that are attached to the wall section and to the cavity floor.

12. The light fixture of claim 9, wherein the upper heat sink comprises exterior fins that extend out from the wall section, from the base section, or from both.

13. The light fixture of claim 9, wherein the upper heat sink and the lower heat sink each comprise an electrical cable routing hole for routing an electrical cable to the light module.
